(19) United States
(12) Patent Application Publication
(10) Pub. No.: US 2008/0235052 A1
(43) Pub. Date: Sep. 25, 2008

(54) SYSTEM AND METHOD FOR SHARING MEDICAL INFORMATION BETWEEN IMAGE-GUIDED SURGERY SYSTEMS

(75) Inventors: Laurent Jacques Node-Langlois, Boston, MA (US); Ronald Andrew von Jako, Saugus, MA (US); Michael Thomas Hurd, Andover, MA (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/687,935

(22) Filed: Mar. 19, 2007

(51) Int. Cl. G06F 19/00

(52) U.S. Cl. 705/3; 600/424; 705/2

(57) ABSTRACT

An expert image-guided surgical system and method for accessing, storing and sharing medical information between expert imaging apparatus for use during the planning and performance of surgical procedures.

### BACKGROUND OF THE INVENTION

This disclosure relates generally to image-guided surgery systems (or surgical navigation systems). In particular, this disclosure relates to an expert image-guided surgery system and a method of sharing medical information between expert image-guided surgery systems for use during surgical procedures.

Image-guided surgery systems track the precise location of surgical instruments and implants in relation to multidimensional images of a patient's anatomy. Additionally, image-guided surgery systems use visualization tools to provide the surgeon with co-registered views of these surgical instruments and implants with the patient's anatomy. The multidimensional images of a patient's anatomy may include computed tomography (CT) imaging data, magnetic resonance (MR) imaging data, positron emission tomography (PET) imaging data, ultrasound imaging data, X-ray imaging data, or any other suitable imaging data, as well as any combinations thereof. Image-guided surgery technology has been applied to a wide variety of medical procedures including cranial neurosurgeries; neurointerventions; ear, nose and throat (ENT) procedures; spinal surgeries; orthopedic surgeries; aortic stenting procedures, etc.

Several of these medical procedures, including spinal and orthopedic surgical procedures, require very precise planning for placement of surgical instruments and/or implants that are internal to the body and difficult to view during the procedure. For example, the placement of pedicle screws during spinal surgery require precise planning and visualization of the entry points and the projected path of instruments and implants through the pedicle bone to their desired position. Also, knee replacement surgery or hip replacement surgery, require precise planning and placement of implants to their most desired position for long term surgical success and pain free use by a patient undergoing such a procedure.

X-ray fluoroscopy is widely used for imaging the musculoskeletal frame during surgical procedures. CT imaging is commonly used as the gold standard for diagnosing deformities and trauma to the spine, joints, and extremities by both orthopedic surgeons and neurosurgeons. Planning for corrective spinal surgery can often be challenging for such conditions as scoliosis, kyphosis and ankylosing spondylosis, and even more challenging when planning for reduction and stabilization of the spine due to spinal trauma and/or to repair neuralgic deficits. These surgeries all vary on a case-by-case basis and some surgeons may be more experienced in one type of procedure versus another, and may see more or less of these procedures in one practice versus another practice. For these reasons, surgeons often consult one another for comparing experiences or to determine how best to treat a patient, including referring the patient to a specialist or other medical facility that specializes in a particular disease, condition, treatment, or procedure.

When considering a patient with trauma to their extremities, and planning for execution of a surgical treatment, the ability to best treat a patient and carry out a successful surgical procedure depends highly on the surgeon's experience and available information. The problem that faces most orthopedic surgeons today is successfully treating multi-fragmented complex joints and other joint procedures, including treating fractures and trauma to the feet and hands. With improved and additional information available to a surgeon, the success rate and longevity of surgical success for the patient increases.

By recognizing particular patient morbidity patterns, their age, growth patterns, underlying disease, living habits, demographics and prior corrective surgical techniques, the prediction and treatment of spinal and orthopedic diseases and conditions may lead to a best plan of surgical action for treating various diseases, deformities, traumas, multiple fractures and other conditions. Since most surgeons do not see and treat all types of pathologies equally, the advantage of a system and method to pool, compute, and share the experiences of different medical facilities and surgeons, and offer meaningful recommendations for identifying diseases and conditions, knowing how to treat and carry out a surgical procedure on these diseases and conditions; the surgeon with this quasi computer atlas of data, may more quickly arrive at a best course of action for treatment by allowing this previously recorded data to be available for each surgeon user and unique patient need.

Therefore, there is a need for a system and method for storing patient data, treatment data, surgical data, and patient outcome data on an image-guided surgery system and making the data available to surgeons when planning for and carrying out various surgical procedures on new patients resulting in better patient outcomes.

### BRIEF DESCRIPTION OF THE INVENTION

In an embodiment, an expert image-guided surgery system comprising a navigation apparatus, at least one imaging apparatus coupled to the navigation apparatus for performing imaging of a patient and resulting in a plurality of images of the patient in a surgical region of interest, at least one computer coupled to the surgical navigation apparatus and the imaging apparatus, at least one data storage device for storing data, a communication interface for receiving and transmitting data, and at least one display for displaying data, wherein the data includes a plurality of data relating to previous surgical procedures performed on other patients that a surgeon may use for improving the results of similar surgical procedures while planning and/or performing the surgical procedures.

In an embodiment, an expert imaging apparatus comprising at least one computer, at least one data storage device for storing data, and a communication interface for transmitting and receiving data.

In an embodiment, a network of expert imaging apparatus comprising at least two imaging apparatus, each imaging apparatus having at least one data storage device for storing data, and each imaging apparatus having a network interface for receiving and transmitting data; and a hub coupled to each imaging apparatus through a communications channel for controlling the transfer of data between the at least two imaging apparatus.

In an embodiment, a method for performing image-guided surgery using an expert image-guided surgery system comprising transferring data onto the image-guided surgery system, performing imaging of a patient with an imaging apparatus, resulting in a plurality of images of the patient in a region of interest, analyzing the plurality of images and selecting data of similar cases of other patients from the data transferred onto the image-guided surgery system, providing the selected data of similar cases to a user on a display, reviewing the selected data of similar cases, performing a surgical procedure; and adjusting the surgical procedure as necessary, based on the selected data of similar cases.

In an embodiment, a method for performing image-guided surgery using an expert image-guided surgery system comprising transferring data onto the image-guided surgery system, performing imaging of a patient with an imaging apparatus, resulting in a plurality of images of the patient in a region of interest, analyzing the plurality of images and selecting data of similar cases of other patients from the data transferred onto the image-guided surgery system, providing the selected data of similar cases to a user on a, display, reviewing the selected data of similar cases, positioning an implant in the patient, analyzing the implant position and comparing it to implant position data from the selected data of similar cases, and adjusting the implant position as necessary, based on the implant position data from the selected data of similar cases.

In an embodiment, a method for performing image-guided surgery using a network of expert imaging apparatus comprising performing imaging of a patient with an imaging apparatus, resulting in a plurality of images of the patient in a region of interest, accessing the network of expert imaging apparatus for data relating to previous surgical cases of other patients that a surgeon may use for improving the results of a similar surgical procedure, analyzing the plurality of images and selecting data of similar cases from the data relating to previous surgical cases of other patients, providing the selected data of similar cases to a user on a display, comparing the selected data of similar cases to the surgical procedure being performed, and adjusting the surgical procedure as necessary, based on the selected data of similar cases.

In an embodiment, a computer program product for use with a computer, the computer program product comprising a computer-usable medium with computer readable instructions stored thereon for execution by a processor, the computer readable instructions performing a method comprising transferring data onto an imaging apparatus, analyzing a plurality of images taken by the imaging apparatus and selecting data of similar cases of other patients from the data transferred onto the imaging apparatus, providing the selected data of similar cases to a user on a display, comparing, the selected data of similar cases to the surgical procedure being performed, and providing suggestions for adjusting the surgical procedure as necessary, based on the selected data of similar cases.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an exemplary embodiment of an expert image-guided surgery system;

FIG. 2 is a block diagram of an exemplary embodiment of an expert image-guided surgery system;

FIG. 3 is a block diagram of an exemplary embodiment of an expert imaging apparatus;

FIG. 4 is a block diagram of an exemplary embodiment of a network of expert imaging apparatus;

FIG. 5 is a flow diagram of an exemplary embodiment of a method for performing image-guided surgery using an expert image-guided surgery system;

FIG. 6 is a flow diagram of an exemplary embodiment of a method for performing image-guided surgery using an expert image-guided surgery system;

FIG. 7 is a block diagram of an exemplary embodiment of a local area network (LAN) of expert image-guided surgery systems;

FIG. 8 is a block diagram of an exemplary embodiment of a wide area network (WAN) of expert image-guided surgery systems; and

FIG. 9 is a flow diagram of an exemplary embodiment of a method for performing image-guided surgery using a network of expert image-guided surgery systems.

### DETAILED DESCRIPTION OF THE INVENTION

In surgical procedures, access to the body is obtained through one or more small percutaneous incisions or one larger incision in the body. Surgical instruments and/or implants are inserted through these openings and directed to a region of interest within the body. Direction of the surgical instruments or implants through the body is facilitated by navigation technology wherein the real-time location of a surgical instrument or implant is measured and virtually superimposed on an image of the region of interest. The image may be a pre-acquired image, or an image obtained in near real-time or real-time using known imaging technologies such as computed tomography (CT), magnetic resonance (MR), positron emission tomography (PET), ultrasound, X-ray, or any other suitable imaging technology, as well as any combinations thereof.

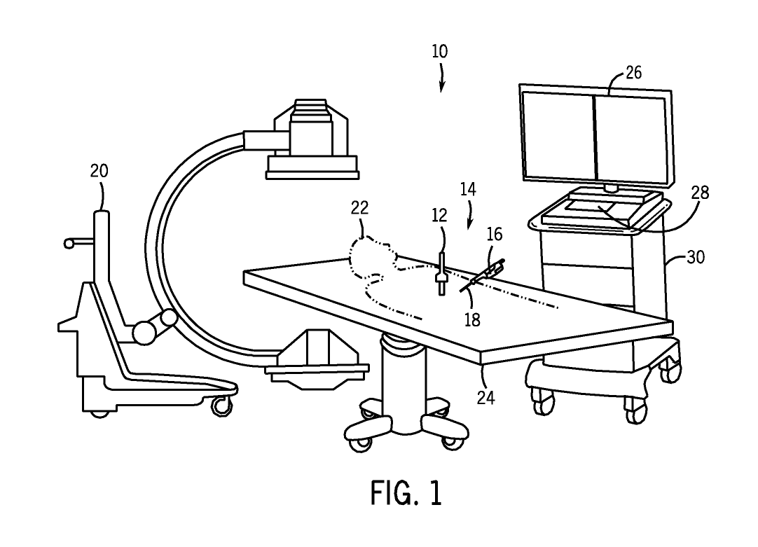

Referring now to FIG. 1, an expert image-guided surgery system (e.g., a surgical navigation system), designated generally by reference numeral 10 is illustrated. The system 10 includes at least one electromagnetic field generator 12 positioned proximate to a surgical field of interest 14; at least one electromagnetic sensor 16 attached to at least one navigated surgical instrument 18 to which an implant may be attached, the at least one electromagnetic sensor 16 communicating with and receiving data from the at least one electromagnetic field generator 12; a navigation apparatus 30 coupled to and receiving data from the at least one electromagnetic sensor 16 and the at least one electromagnetic field generator 12; at least one imaging apparatus 20 coupled to the navigation apparatus 30 for performing imaging on a patient 22 in the surgical field of interest 14, the system of FIG. 1 showing the patient 22 positioned on a table 24 during a surgical procedure; and at least one display 26 coupled to the navigation apparatus 30 for displaying imaging and tracking data from the image-guided surgery system.

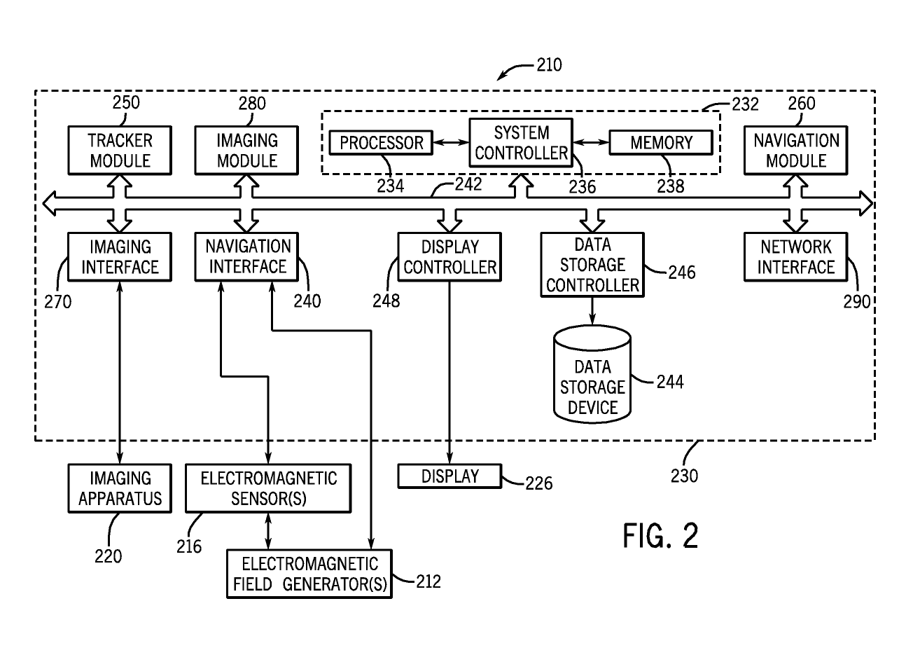

The navigation apparatus 30 may include at least one computer; at least one interface for communicating with the imaging apparatus 20, the at least one electromagnetic field generator 12, and the at least one electromagnetic sensor 16; a tracker module; a navigation module; an imaging module; and at least one storage device. The at least one computer includes integrated planning software stored thereon for execution by the computer allowing a surgeon to plan and expertly perform a surgical procedure using data relating to similar cases of other patients that the surgeon may use for improving the performance and results of a current surgical procedure. A further description of these components and their operation are described with reference to FIG. 2 below.

The display 26 is configured to show the image based registration process as it is progressing. The display 26 is also configured to show the real-time position and orientation of the at least one surgical instrument 18 or at least one implant attached to the tip or end of the at least one surgical instrument 18 on a registered image of the patient's anatomy. The graphical reference of the at least one surgical instrument 18 or at least one implant depicted on the display may appear as a line rendering, a few simply shaded geometric primitives, or a realistic 3D model from a computer-aided design (CAD) file.

The image-guided surgery system 10 is configured to operate with at least one electromagnetic field generator 12 and at least one electromagnetic sensor 16 to determine the position and orientation of the at least one device 18 or an implant. The at least one electromagnetic field generator 12 and the at least one electromagnetic sensor 16 may be coupled to a navigation interface on the navigation apparatus 30 through either a wired or wireless connection.

In an exemplary embodiment, the at least one electromagnetic field generator 12 may be an electromagnetic field transmitter. The electromagnetic field transmitter may be a transmitter coil array including at least one coil, at least one coil pair, at least one coil trio, or a coil array for generating an electromagnetic field in response to a current being applied to at least one coil. In an exemplary embodiment, the at least one electromagnetic sensor 16 may be an electromagnetic field receiver including at least one coil, at least one coil pair, at least one coil trio, or a coil array with electronics for digitizing magnetic field measurements detected by the electromagnetic field receiver. The electromagnetic field receiver detecting the electromagnetic field being generated by the electromagnetic field transmitter. It should, however, be appreciated that according to alternate embodiments the at least one electromagnetic field generator may be an electromagnetic sensor or an electromagnetic field receiver, and the at least one electromagnetic sensor may be an electromagnetic field generator.

In an exemplary embodiment, the at least one electromagnetic field generator 12 or an additional electromagnetic field generator may act as a dynamic reference that may be rigidly attached to the patient 22 in the surgical field of interest 14. This dynamic reference generates a different electromagnetic field (e.g., a different frequency) from the other electromagnetic field generators, and creates a local reference frame for the navigation system around the patient's anatomy in the surgical field of interest. Typically, the dynamic reference used by a navigation system is registered to the patient's anatomy prior to surgical navigation. Registration of the reference frame impacts the accuracy of a navigated instrument in relation to a displayed image.

The system 10 enables a surgeon to continually track the position and orientation of the surgical instrument 18 or an implant attached to the surgical instrument 18 during surgery. The at least one electromagnetic field generator 12 may include at least one coil for generating an electromagnetic field. A current is applied from the navigation apparatus 30 to the at least one coil of the at least one electromagnetic field generator 12 to generate a magnetic field around the at least one electromagnetic field generator 12. The at least one electromagnetic sensor 16 may include at least one coil for detecting the magnetic field. The at least one electromagnetic sensor 16 is brought into proximity with the at least one electromagnetic field generator 12 in the surgical field of interest. The magnetic field induces a voltage in the at least one coil of the at least one electromagnetic sensor 16, detecting the magnetic field generated by the at least one electromagnetic field generator 12 for calculating the position and orientation of the at least one surgical instrument 18 or implant. The at least one electromagnetic sensor 16 includes electronics for digitizing magnetic field measurements detected by the at least one electromagnetic sensor 16.

The magnetic field measurements can be used to calculate the position and orientation of the surgical instrument 18 or an implant according to any suitable method or system. After the magnetic field measurements are digitized using electronics, the digitized signals are transmitted from the at least one electromagnetic sensor 16 to the computer on the navigation apparatus 30 through a navigation interface. The digitized signals may be transmitted from the at least one electromagnetic sensor 16 to the navigation apparatus 30 using wired or wireless communication protocols and interfaces. The digitized signals received by the navigation apparatus 30 represent magnetic field information detected by the at least one electromagnetic sensor 16. The digitized signals are used to calculate position and orientation information of the surgical instrument 18 or implant. The position and orientation information is used to register the location of the surgical instrument 18 or implant to acquired imaging data from the imaging apparatus 20. The position and orientation data is visualized on the display 26, showing in real-time the location of the surgical instrument 18 or implant on pre-acquired or real-time images from the imaging apparatus 20. The acquired imaging data from the imaging apparatus 20 may include CT imaging data, MR imaging data, PET imaging data, ultrasound imaging data, X-ray imaging data, or any other suitable imaging data, as well as any combinations thereof. In addition to the acquired imaging data from various modalities, real-time imaging data from various real-time imaging modalities may also be available.

In an exemplary embodiment, the image-guided surgery system 10 may be integrated into a single integrated imaging and navigation system with integrated instrumentation and software.

In an exemplary embodiment, the image-guided surgery system 10 may be an electromagnetic navigation system utilizing electromagnetic navigation technology. However, other tracking or navigation technologies may be utilized as well.

FIG. 2 is a block diagram of an exemplary embodiment of an expert image-guided surgery system 210. The image-guided surgery system 210 is illustrated conceptually as a collection of modules and other components that are included in a navigation apparatus 230, but may be implemented using any combination of dedicated hardware boards, digital signal processors, field programmable gate arrays, and processors. Alternatively, the modules may be implemented using an off-the-shelf computer with a single processor or multiple processors, with the functional operations distributed between the processors. As an example, it may be desirable to have a dedicated processor for position and orientation calculations as well as dedicated processors for imaging operations and visualization operations. As a further option, the modules may be implemented using a hybrid configuration in which certain modular functions are performed using dedicated hardware, while the remaining modular functions are performed using an off-the-shelf computer. In the embodiment shown in FIG. 2, the image-guided surgery system 210 includes a single computer 232 having a processor 234, a system controller 236 and memory 238. The processor 234 is programmed with integrated planning software to select data from surgical cases, similar to the surgical procedure being planned and performed on a current patient, that is stored on a data storage device of the expert image-guided surgery system 210 and presented to a surgeon on a display. The operations of the modules and other components of the navigation apparatus 230 may be controlled by the system controller 236.

The image-guided surgery system 210 includes at least one electromagnetic field generator 212 that is coupled to a navigation interface 240. The at least one electromagnetic field generator 212 generates at least one electromagnetic field that is detected by at least one electromagnetic field sensor 216. The navigation interface 240 receives digitized signals from at least one electromagnetic sensor 216. The navigation interface 240 includes at least one Ethernet port. The at least one Ethernet port may be provided, for example, with an Ethernet network interface card or adapter. However, according to various alternate embodiments, the digitized signals may be transmitted from the at least one electromagnetic sensor 216 to the navigation interface 240 using alternative wired or wireless communication protocols and interfaces.

The digitized signals received by the navigation interface 240 represent magnetic field information from the at least one electromagnetic field generator 212 detected by the at least one electromagnetic sensor 216. In the embodiment illustrated in FIG. 2, the navigation interface 240 transmits the digitized signals to a tracker module 250 over a local interface 242. The tracker module 250 calculates position and orientation information based on the received digitized signals. This position and orientation information provides a location of a surgical instrument or implant.

In an exemplary embodiment, the at least one electromagnetic field generator 212 and the at least one electromagnetic sensor 216 may be coupled to the navigation interface 240 through either a wired or wireless connection.

The tracker module 250 communicates the position and orientation information to a navigation module 260 over a local interface 242. As an example, this local interface 242 is a Peripheral Component Interconnect (PCI) bus. However, according to various alternate embodiments, equivalent bus technologies may be substituted.

Upon receiving the position and orientation information, the navigation module 260 is used to register the location of the surgical instrument or implant to acquired patient data. In the embodiment illustrated in FIG. 2, the acquired patient data is stored on a data storage device 244. The acquired patient data may include CT data, MR data, PET data, ultrasound data, X-ray data, or any other suitable data, as well as any combinations thereof. By way of example only, the data storage device 244 is a hard disk drive, but other suitable storage devices may be used.

Patient imaging data acquired prior to the procedure may be transferred to the system 210 and stored on a data storage device 244. The acquired patient data is loaded into memory 238 from the data storage device 244. The acquired patient data is retrieved from the data storage device 244 by a data storage device controller 246. The navigation module 260 reads from memory 238 the acquired patient data. The navigation module 260 registers the location of the surgical instrument or implant to acquired patient data, and generates image data suitable to visualize the patient image data and a representation of the surgical instrument or implant. The image data is transmitted to a display controller 248 over a local interface 242. The display controller 248 is used to output the image data to display 226.

The data storage device 244 may also be used for storing a plurality of data relating to patient medical records and a plurality of data relating to previous surgical cases of other patients that a surgeon may use for improving the results of a current surgical procedure while planning and/or performing the procedure.

The patient medical records data may include the patient's age, demographics, growth patterns, morbidity patterns, daily living habits, medical history, family medical history, underlying diseases, prior medical procedures, medications, and other data, etc. The previous surgical case data may include data from similar medical or surgical procedures including treatments, techniques, instrument positions, implant positions, patient outcomes from follow-ups, etc. This data may also include anatomical measurements and clinical data. The form of the data may include calculations, text, images, videos, etc. The data collected from surgeons and clinical specialists is continually being updated and transferred to expert image-guided surgery systems or other systems having data storage devices in real-time.

This data may be transferred to the system 210 through a network interface 290 and stored on the data storage device 244. The data in data storage device 244 is controlled by data storage device controller 246. The data may be transferred to the display controller 248 over local interface 242 for viewing on display 226. The network interface 290 is coupled to local interface 242 for transmitting and receiving data. The network interface 290 provides the ability to transmit and receive data to and from other devices and/or systems having a similar interface.

The image-guided surgery system 210 may further include an imaging apparatus 220 coupled to an imaging interface 270 for receiving real-time imaging data. The imaging data is processed in an imaging module 280. The imaging apparatus 220 provides the ability to display real-time imaging data in combination with position and orientation information of a surgical instrument or implant on the display 226.

While one display 226 is illustrated in the embodiment in FIG. 2, alternate embodiments may include various display configurations. Various display configurations may be used to improve operating room ergonomics, display different views, or display information to personnel at various locations.

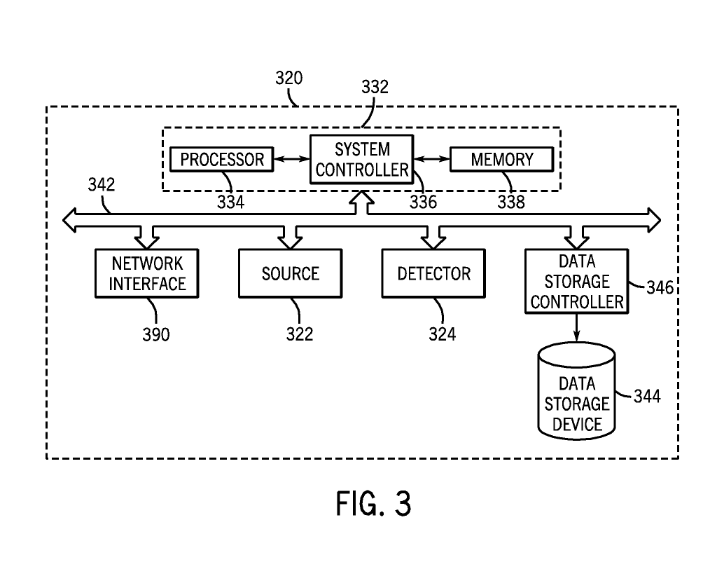

FIG. 3 is a block diagram of an exemplary embodiment of an expert imaging apparatus 320. The expert imaging apparatus 320 may include a computer 332 having a processor 334, a system controller 336 and memory 338. The processor 334 is programmed with integrated planning software to select data from surgical cases, similar to the surgical procedure being planned and performed on a current patient, that is stored on a data storage device of the expert imaging apparatus 320 and presented to a surgeon on a display. The operation of the expert imaging apparatus 320 may be controlled by system controller 336. The expert imaging apparatus 320 further comprises a source 322, a detector 324, a network interface 390, a data storage device 344, and a data storage controller 346. As an example, the source on an X-ray or CT imaging apparatus is an X-ray or radiation source, and the detector on an X-ray or CT imaging apparatus is an X-ray or radiation detector. The data storage device 344 may be used for storing a plurality of data and the network interface 390 may be used for receiving and transmitting data to and from image-guided surgery systems as well as other imaging apparatus.

The computer 332 communicates with source 322, detector 324, data storage, controller 346, and network interface 390 over a local interface 342. As an example, this local interface 342 is a Peripheral Component Interconnect (PCI) bus. However, according to various alternate embodiments, equivalent bus technologies may be substituted.

Acquired patient imaging data is stored on data storage device 344. The acquired patient imaging data may include CT data, MR data, PET data, ultrasound data, X-ray data, or any other suitable data, as well as any combinations thereof. By way of example only, the data storage device 344 is a hard disk drive, but other suitable storage devices may be used.

The data storage device 344 may also be used for storing a plurality of data relating to patient medical records and a plurality of data relating to previous surgical cases of other patients that a surgeon may use for improving the results of a current surgical procedure while planning and/or performing the procedure.

The patient medical records data may include the patient's age, demographics, growth patterns, morbidity patterns, daily living habits, medical history, family medical history, underlying diseases, prior medical procedures, medications, and other data, etc. The previous surgical case data may include data from similar medical or surgical procedures including treatments, techniques, instrument positions, implant positions, patient outcomes from follow-ups, etc. This data may also include anatomical measurements and clinical data. The form of the data may include calculations, text, images, videos, etc. The data collected from surgeons and clinical specialists is continually being updated and transferred to expert imaging apparatus or other systems having data storage devices in real-time.

This data may be transferred to the imaging apparatus 320 and stored on data storage device 344 using network interface 290, local interface 342, and data storage controller 346. The data is transferred to and retrieved from data storage device 344 by data storage device controller 346. The data may be transmitted to a display through network interface 390.

The network interface 390 is coupled to local interface 342 for transmitting and receiving data. The network interface 390 provides the ability to transmit and receive data to and from other devices and/or systems having a similar interface.

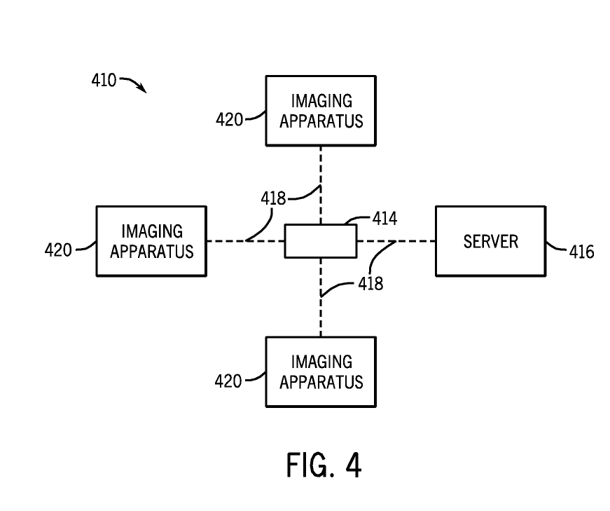

FIG. 4 is a block diagram of an exemplary embodiment of a network 410 of expert imaging apparatus 420. The network 400 comprises two or more imaging apparatus 420 and at least one server 416 that are coupled together to share information. The network 400 allows medical data or other information to be shared between the server 416 and the apparatus 420. The network 400 may be located within a clinic, surgical center, hospital or other medical facility, where a patient examination or medical procedure or is being conducted. Data obtained by one apparatus 420 may be transferred over a communications network to server 416 for storage in at least one database and on to another apparatus 420 coupled to the network.

Each apparatus 420 and server 416 includes a network interface to allow an apparatus 420 or server 416 to send and receive communications from other apparatus 420 or server 416 having network interfaces that are coupled to the network. The server 416 and apparatus 420 may be coupled to the network directly, or through some type of communications hub 414. The hub 414 is coupled to server 416 and each apparatus 420 through a communications channel 418. The communications channel 418 may be implemented using a modem, or any other type of network connection known in the art for this purpose, including Ethernet, ATM, DSL, cable modem, ISDN, infrared, or wireless connections such as Bluetooth or IEEE 802.11. The data may also be transferred over other suitable network connections such as DICOM or the Medical Information Bus. The hub 414 implements a communication protocol to control communications and efficiently transfer and receive data between server 416 and apparatus 420 coupled to the network.

In an exemplary embodiment, the server 416 may be a hospital server that includes at least one database where data and images from previous patient cases (diagnosis to follow-up) are stored. In an exemplary embodiment, the server 416 may be coupled to a PACS (picture archiving and communications system). PACS are computers and/or networks dedicated to the storage, retrieval, distribution and presentation of medical images. In an exemplary embodiment, the server 416 may also interface with a hospital information system (HIS) and a radiology information system (RIS).

A PACS includes interfaces to imaging apparatus, at least one server that includes at least one database for storing images, one or more computer workstations to view the images, and a computer network to link the imaging apparatus, at least one server, and the one or more computer workstations. The PACS provides a single point of access for images and their associated data. Communications between PACS, HIS and RIS are often implemented using a standard called Health Level 7 (HL7) for the electronic exchange of medical information. By being PACS and HL7 compliant, one may be able to get relevant data according to actual patient cases.

The networked expert imaging apparatus allows physicians and other healthcare professionals to review current medical data and images and instantly compare them with data and images from previous cases. The networked expert imaging apparatus provides access to data and images relating to previous surgical procedures performed on other patients that a physician may use for improving the results of similar surgical procedures while planning and/or performing a surgical procedure.

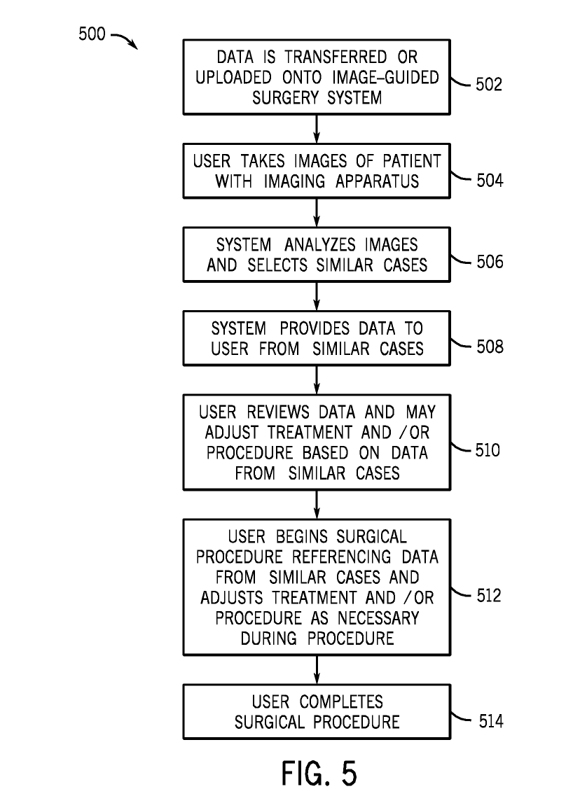

FIG. 5 is a flow diagram of an exemplary embodiment of a method 500 for performing image-guided surgery using an expert image-guided surgery system. The method begins at step 502, when data is transferred or uploaded onto an image-guided surgery system. The user takes images of a patient with an imaging apparatus at step 504. At step 506, the image-guided surgery system analyses the images and selects similar patient cases from its data storage device or memory. The image-guided surgery system presents data relating to the similar patient cases selected and the patient outcomes to the user at step 508. At step 510, the user reviews the data and may or may not adjust the treatment and/or procedure based on the data from similar cases. The user begins the surgical procedure referencing the data from similar cases and adjusting treatment and/or procedures as necessary during the procedure at step 512. At step 514, the user completes the surgical procedure.

In an exemplary embodiment, the image-guided surgery system may include an expert imaging apparatus and integrated planning software stored on a computer for execution by the computer that allows a surgeon to plan and expertly perform a surgical procedure. The data relating to patient medical records and similar cases of other patients that a surgeon may use for improving the performance and results of a current surgical procedure may be transferred and stored in a data storage device or memory within the expert image-guided surgery system or the expert imaging apparatus.

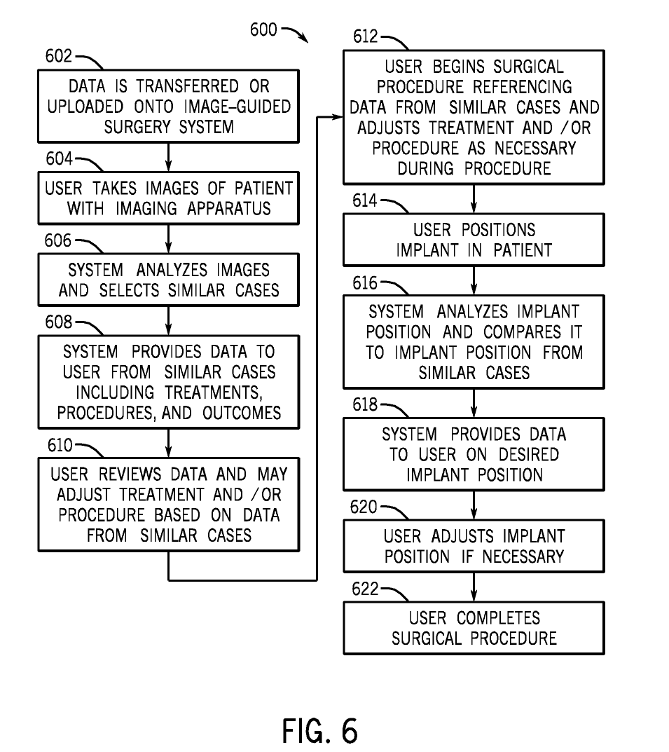

FIG. 6 is a flow diagram of an exemplary embodiment of a method 600 for performing image-guided surgery using an expert image-guided surgery system. The method begins at step 602, when data is transferred or uploaded onto an image-guided surgery system. The user takes images of a patient with an imaging apparatus at step 604. At step 606, the image-guided surgery system analyses the images and selects similar patient cases from its data storage device or memory. The image-guided surgery system presents data relating to the similar patient cases selected and the patient outcomes to the user at step 608. At step 610, the user reviews the data and may or may not adjust the treatment and/or procedure based on the data from similar cases. The user begins the surgical procedure referencing the data from similar cases and adjusting treatment and/or procedures as necessary during the procedure at step 612. At step 614, the user positions an implant in the patient anatomy. The position of the implant is crucial. A misplaced implant could lead to heavy complications and a new surgery. The image-guided surgery system analyses the implant position and compares it to implant positions from similar cases at step 616. The image-guided surgery system provides data to the user on the desired implant position at step 618. This information helps the user decide the best position for the implant for this case according to the planning and the expert analysis done by the system based on multiple cases. The user adjusts the position of the implant if necessary at step 620. At step 622, the user completes the surgical procedure.

In an exemplary embodiment, the image-guided surgery system may include an expert imaging apparatus and integrated planning software stored on a computer for execution by the computer that allows a surgeon to plan and expertly perform a surgical procedure. The data relating to patient medical records and similar cases of other patients that a surgeon may use for improving the performance and results of a current surgical procedure may be transferred and stored in a data storage device or memory within the expert image-guided surgery system or the expert imaging apparatus.

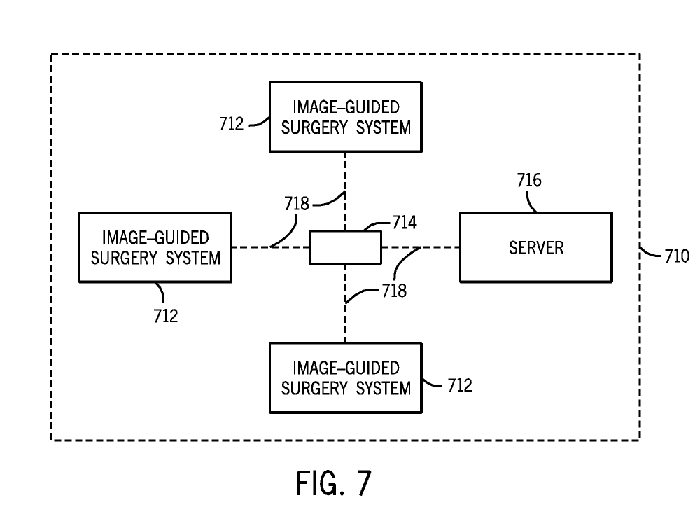

FIG. 7 is a block diagram of an exemplary embodiment of a local area network (LAN) 710 of expert image-guided surgery systems 712. The network 710 comprises two or more image-guided surgery systems 712 and at least one server 716 that are coupled together to share information. The network 710 allows medical data or other information to be shared between server 716 and systems 712. The network 710 may be located within a clinic, surgical center, hospital or other medical facility, where a patient examination or medical procedure or is being conducted. Data obtained by one system 712 may be transferred over a communications network to server 716 for storage in at least one database and on to another system 712 coupled to the network.

Each system 712 and server 716 includes a network interface to allow a system 712 or server 716 to send and receive communications from other systems 712 or server 716 having network interfaces that are coupled to the network. The server 716 and systems 712 may be coupled to the network directly, or through some type of communications hub 714. For example, an imaging apparatus may be coupled to the network. An imaging apparatus generally transfers data as an NTSC video signal, and is adapted to interface to a hub. The hub 714 is coupled to server 716 and each system 712 through a communications channel 718. The communications channel 718 may be implemented using a modem, or any other type of network connection known in the art for this purpose, including Ethernet, ATM, DSL, cable modem, ISDN, infrared, or wireless connections such as Bluetooth or IEEE 802.11. The data may also be transferred over other suitable network connections such as DICOM or the Medical Information Bus. The hub 714 implements a communication protocol to control communications and efficiently transfer and receive data between server 716 and systems 712 coupled to the network. A data processing apparatus (not shown), such as a computer or other processor, within each system 712 executes software that allows data to be received and viewed on a display.

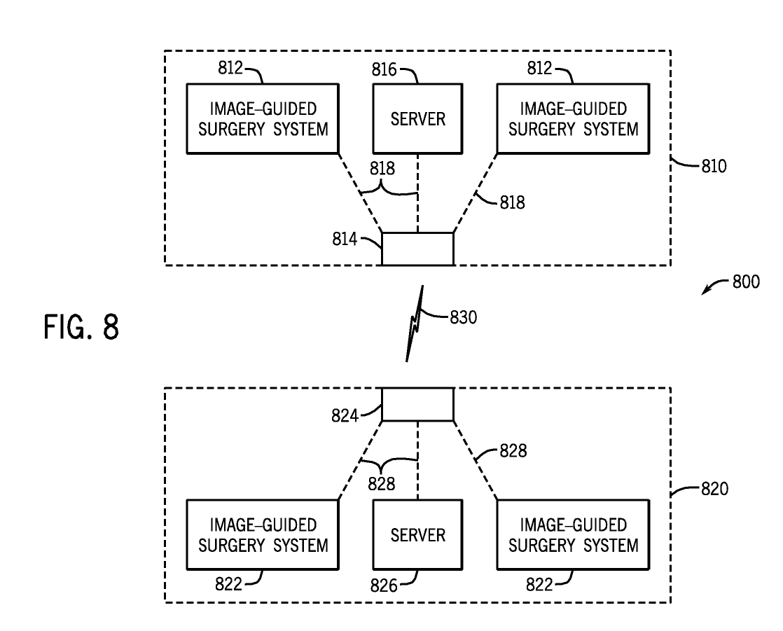

FIG. 8 is a block diagram of an exemplary embodiment of a wide area network (WAN) 800 of expert image-guided surgery systems. The WAN 800 comprises two or more LANs 810, 820, or two or more image-guided surgery systems 812, 822 and servers 814, 824 coupled together to share information. Medical data may be shared among servers 814, 824 and systems 812, 822 in LANs 810 and 820. The WAN 800 allows medical data or other information from server 816 and systems 812 in LAN 810 to be shared with server 824 and systems 822 in LAN 820. The first LAN 810 may be located within a clinic, surgical center, hospital or other medical facility, and the second LAN 820 may be located within a different clinic, surgical center, hospital or other medical facility. The WAN 800 allows medical data obtained by systems 812 at a first site 810 to be transferred to server 816 and on to server 826 and systems 822 at a second site 820. This medical data may include imaging data, video data or other data obtained from one or more medical devices such as a fluoroscopy imaging apparatus or a surgical navigation apparatus.

In the first LAN 810, data obtained by one system 812 or server 816 may be transferred over a communications path 818 to a hub 814 and on to another system 812 or server 816 over a communications path 818. Likewise, in the second LAN 820, data obtained by one system 822 or server 826 may be transferred over a communications path 828 to a hub 824 and on to another system 822 or server 826 over a communications path 828. The communications path 818, 828 from one system 812, 822 or server 826, 826 to the next system 812, 822 or server 826, 828 may or may not be the same.

Each of the servers 816, 826 and systems 812, 822 include a network interface (not shown) to allow a system 812, 822 or server 816, 826 to send and receive communications from other systems 812, 822 or servers 816, 826. The systems 812, 822 or servers 816, 826 may be coupled to a WAN communications network 830 directly, or through some type of communications hub 814, 824. The hub 814, 824 is coupled to each server 816, 826 and system 812, 822 through a communications channel 818, 828. The communications channel 818, 828 may be implemented using a modem, or any other type of network connection known in the art for this purpose, including Ethernet, ATM, DSL, cable modem, ISDN, infrared, or wireless connections such as Bluetooth or IEEE 802.11. The data may also be transferred over other suitable network connections such as DICOM or the Medical Information Bus. The hub 814, 824 implements a communication protocol to control communications and efficiently transfer and receive data between servers 816, 826 and systems 812, 822. A data processing apparatus (not shown), such as a computer or other processor, within each system 812, 822 executes software that allows data to be received and viewed on a display.

Data obtained by LAN 810 may be transferred over the WAN communications network 830 to LAN 820. The WAN communications network 830 may communicate with hubs 814, 824, or directly with servers 816, 826 and systems 812, 822. The WAN communications network 830 may be implemented using a modem, Ethernet, ATM, DSL, cable modem, ISDN, infrared, Internet, intranet, extranet or wireless connections such as Bluetooth or IEEE 802.11, for example.

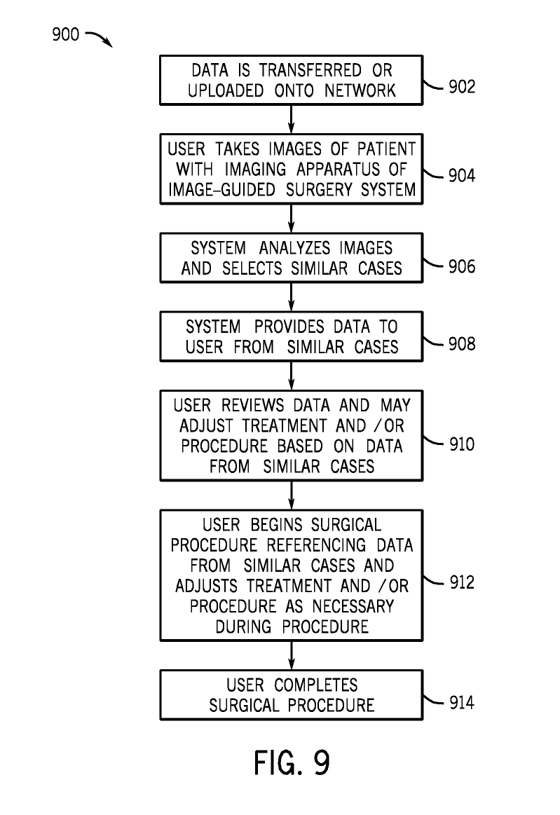

FIG. 9 is a flow diagram of an exemplary embodiment of a method 900 for performing image-guided surgery using a network of expert image-guided surgery systems or expert imaging apparatus. The method begins at step 902, when data is transferred or uploaded onto the network making it available to any device, apparatus or system coupled to the network. The user takes images of a patient with an imaging apparatus at step 904. At step 906, the image-guided surgery system analyses the images and selects similar patient cases from its data storage device or memory. The image-guided surgery system presents data relating to the similar patient cases selected and the patient outcomes to the user at step 908. At step 910, the user reviews the data and may or may not adjust the treatment and/or procedure based on the data from similar cases. The user begins the surgical procedure referencing the data from similar cases and adjusting treatment and/or procedures as necessary during the procedure at step 912. At step 914, the user completes the surgical procedure.

In an exemplary embodiment, the image-guided surgery system may include an expert imaging apparatus and integrated planning software stored on a computer for execution by the computer that allows a surgeon to plan and expertly perform a surgical procedure. The data relating to patient medical records and similar cases of other patients that a surgeon may use for improving the performance and results of a current surgical procedure may be transferred and stored in a data storage device or memory within the expert image-guided surgery system or the expert imaging apparatus.

The expert image-guided surgery system functions as a virtual data collection library of information on a variety of surgical cases and procedures relating to the spine, joints, extremities and orthopedics. It allows the surgeon to review and evaluate the data, as well as prepare treatment plans based on the data, with a network of systems containing up-to-date medical knowledge and electronic data banks with patient data. It also allows inexperienced surgeons to benefit from the expertise of more experienced surgeons during a surgical procedure. The expert image-guided surgery system provides a benefit of being able to use knowledge learned from previous cases and experiences to improve current surgical procedures taking place inside operative rooms.

It should be appreciated that according to alternate embodiments, the at least one electromagnetic sensor may be an electromagnetic receiver, an electromagnetic field generator (transmitter), or any combination thereof. Likewise, it should be appreciated that according to alternate embodiments, the at least one electromagnetic field generator may be an electromagnetic receiver, an electromagnetic transmitter or any combination of an electromagnetic field generator (transmitter) and an electromagnetic receiver.

Several embodiments are described above with reference to drawings. These drawings illustrate certain details of specific embodiments that implement the systems, methods and programs of the invention. However, the drawings should not be construed as imposing on the invention any limitations associated with features shown in the drawings. This disclosure contemplates methods, systems and program products on any machine-readable media for accomplishing its operations. As noted above, the embodiments of the may be implemented using an existing computer processor, or by a special purpose computer processor incorporated for this or another purpose or by a hardwired system.

As noted above, embodiments within the scope of the included program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

Those skilled in the art will appreciate that the embodiments disclosed herein may be applied to the formation of any image-guided surgery system. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to various embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. An expert image-guided surgery system comprising:
a navigation apparatus;
at least one imaging apparatus coupled to the navigation apparatus for performing imaging of a patient and resulting in a plurality of images of the patient in a surgical region of interest;
at least one computer coupled to the surgical navigation apparatus and the imaging apparatus;
at least one data storage device for storing data;
a communication interface for receiving and transmitting data; and
at least one display for displaying data;
wherein the data includes a plurality of data relating to previous surgical procedures performed on other patients that a surgeon may use for improving the results of similar surgical procedures while planning and/or performing the surgical procedures.

2. The expert image-guided surgery system of claim 1, wherein the communication interface is wireless.

3. The expert image-guided surgery system of claim 1, wherein the at least one imaging apparatus is an expert imaging apparatus.

4. The expert image-guided surgery system of claim 3, wherein the expert imaging apparatus includes a data storage device for storing data and a communication interface for receiving and transmitting data.

5. The expert image-guided surgery system of claim 1, wherein the data includes data relating to patient medical records.

6. The expert image-guided surgery system of claim 1, wherein the at least one computer and the at least one data storage device are part of a server in a medical facility.

7. The expert image-guided surgery system of claim 1, wherein the at least one computer searches the plurality of data to find data on similar surgical procedures performed on other patients in its database by doing a comparison of the plurality of patient images and the type of surgical procedure being performed.

8. The expert image-guided surgery system of claim 1, wherein the at least one computer has integrated planning software stored thereon for execution by the computer allowing a surgeon to plan and expertly perform a surgical procedure using data relating to similar cases of other patients that the surgeon may use for improving the performance and results of a current surgical procedure.

9. An expert imaging apparatus comprising:
at least one computer;
at least one data storage device for storing data; and
a communication interface for transmitting and receiving data.

10. The expert imaging apparatus of claim 9, further comprising a source.

11. The expert imaging apparatus of claim 10, wherein the source is an X-ray source.

12. The expert imaging apparatus of claim 10, further comprising a detector.

13. The expert imaging apparatus of claim 12, wherein the detector is an X-ray detector.

14. The expert imaging apparatus of claim 9, wherein the communication interface is wireless.

15. The expert image-guided surgery system of claim 9, wherein the data includes data relating to patient medical records.

16. The expert image-guided surgery system of claim 9, wherein the data includes a plurality of data relating to previous surgical cases of other patients that a surgeon may use for improving the results of similar surgical procedures while planning and/or performing the procedures.

17. The expert image-guided surgery system of claim 9, wherein the at least one computer has integrated planning software stored thereon for execution by the computer allowing a surgeon to plan and expertly perform a surgical procedure using data relating to similar cases of other patients that the surgeon may use for improving the performance and results of a current surgical procedure.

18. A network of expert imaging apparatus comprising:
at least two imaging apparatus, each imaging apparatus having at least one data storage device for storing data, and each imaging apparatus having a network interface for receiving and transmitting data; and
a hub coupled to each imaging apparatus through a communications channel for controlling the transfer of data between the at least two imaging apparatus.

19. The network of expert imaging apparatus of claim 18, wherein the communications channel is wireless.

20. A method for performing image-guided surgery using an expert image-guided surgery system comprising:
transferring data onto the image-guided surgery system;
performing imaging of a patient with an imaging apparatus, resulting in a plurality of images of the patient in a region of interest;
analyzing the plurality of images and selecting data of similar cases of other patients from the data transferred onto the image-guided surgery system;
providing the selected data of similar cases to a user on a display;
reviewing the selected data of similar cases;
performing a surgical procedure; and
adjusting the surgical procedure as necessary, based on the selected data of similar cases.

21. The method of claim 20, wherein the expert image-guided surgery system includes a data storage device for storing data and a communication interface for receiving and transmitting data.

22. The method of claim 20, wherein the expert imaging apparatus includes a data storage device for storing data and a communication interface for receiving and transmitting data.

23. The method of claim 20, wherein the data includes a plurality of data relating to previous surgical cases of other patients that a surgeon may use for improving the results of a similar surgical procedure.

24. A method for performing image-guided surgery using an expert image-guided surgery system comprising:
transferring data onto the image-guided surgery system;
performing imaging of a patient with an imaging apparatus, resulting in a plurality of images of the patient in a region of interest;
analyzing the plurality of images and selecting data of similar cases of other patients from the data transferred onto the image-guided surgery system;
providing the selected data of similar cases to a user on a display;
reviewing the selected data of similar cases;
positioning an implant in the patient;
analyzing the implant position and comparing it to implant position data from the selected data of similar cases; and
adjusting the implant position as necessary, based on the implant position data from the selected data of similar cases.

25. The method of claim 24, wherein the implant position data is provided to the user on the display.

26. The method of claim 24, wherein the implant position data includes the desired implant position data provided to the user on the display.

27. A method for performing image-guided surgery using a network of expert imaging apparatus comprising:
performing imaging of a patient with an imaging apparatus, resulting in a plurality of images of the patient in a region of interest;
accessing the network of expert imaging apparatus for data relating to previous surgical cases of other patients that a surgeon may use for improving the results of a similar surgical procedure;
analyzing the plurality of images and selecting data of similar cases from the data relating to previous surgical cases of other patients;
providing the selected data of similar cases to a user on a display;
comparing the selected data of similar cases to the surgical procedure being performed; and
adjusting the surgical procedure as necessary, based on the selected data of similar cases.

28. A computer program product for use with a computer, the computer program product comprising a computer-usable medium with computer readable instructions stored thereon for execution by a processor, the computer readable instructions performing a method comprising:
transferring data onto an imaging apparatus;
analyzing a plurality of images taken by the imaging apparatus and selecting data of similar cases of other patients from the data transferred onto the imaging apparatus;
providing the selected data of similar cases to a user on a display;
comparing the selected data of similar cases to the surgical procedure being performed; and
providing suggestions for adjusting the surgical procedure as necessary, based on the selected data of similar cases.
